(19) United States
(12) Patent Application Publication
(10) Pub. No.: US 2006/0117301 A1
(43) Pub. Date: Jun. 1, 2006

(54) Computer program and method for establishing, documenting, implementing, and maintaining a quality management system for quality systems assessment and product verification programs

(75) Inventors: Leann Saunders, Dearborn, MO (US); Cory Weaver, Platte Woods, MO (US); Cara Gerken, Cashion, OK (US); John Saunders, Dearborn, MO (US)

Correspondence Address: HOVEY WILLIAMS LLP, 2405 GRAND BLVD., SUITE 400, KANSAS CITY, MO, 64108, US

(73) Assignee: Integrated Management Information, Inc.

(21) Appl. No.: 11/190,245

(22) Filed: Jul. 27, 2005

Related U.S. Application Data
(60) Provisional application No. 60/630,976, filed on Nov. 24, 2004.
(60) Provisional application No. 60/702,716, filed on Jul. 27, 2005.

(51) Int. Cl. G06F 9/44

(52) U.S. Cl. 717/124; 717/101

(57) ABSTRACT

A method of implementing a quality systems management program involves assisting a supplier of agricultural products in developing a quality management program that complies with requirements of a USDA quality systems assessment program. A quality manual is created that includes information relating to the quality management program as well as links to electronic documents that are required by the program, wherein the supplier completes and edits the documents via a remote computer. A USDA representative remotely accesses the completed documents to audit the suppliers quality management protocol to verify conformance with the quality systems assessment program.

### RELATED APPLICATIONS

The present application is a nonprovisional patent application and claims priority benefit, with regard to all common subject matter, of earlier-filed U.S. Provisional Application entitled “COMPUTER PROGRAM AND METHOD FOR ESTABLISHING, DOCUMENTING, IMPLEMENTING, AND MAINTAINING A QUALITY MANAGEMENT SYSTEM FOR A BEEF EXPORT VERIFICATION PROGRAM,” Ser. No. 60/630,976, filed Nov. 24, 2004. This application also claims priority benefit of U.S. Provisional Application Ser. No. ______, entitled “COMPUTER PROGRAM AND METHOD FOR ESTABLISHING, DOCUMENTING, IMPLEMENTING, AND MAINTAINING A QUALITY MANAGEMENT SYSTEM FOR QUALITY SYSTEMS ASSESSMENT AND PRODUCT VERIFICATION PROGRAMS,” and filed Jul. 27, 2005. The identified applications are hereby incorporated by reference into the present application.

### BACKGROUND OF THE INVENTION

1. Field of the Invention

The present invention relates to quality assessment and verification programs for commercial processes. More particularly, the invention relates to a computer program and electronic verification method accessible via a communications network and operable to establish, automate, document, implement, and maintain a quality assessment program for verifying that agricultural products meet requirements of a USDA quality systems assessment (QSA) program or process verified program (PVP) for the verification of agricultural product specifications and claims.

2. Description of the Prior Art

Beef exportation is becoming a growing source of revenue for U.S. beef producers. As global markets open and as U.S. beef becomes more desirable in foreign markets, the amount of beef exported from the U.S. will increase significantly. To address concerns of U.S. beef by foreign importers, the United States Department of Agriculture (“USDA”) has implemented a Quality Systems Assessment Program (the “QSA Program”) for Beef Export Verification (“BEV”). Many countries, such as Mexico and Canada, require compliance with a BEV program before importing U.S. beef. Recent resumption of trade with Japan requires that a company exporting beef to Japan be able to trace live animal production records. Thus, traceability of beef is becoming much more of a concern for cattle growers. This is especially true given concern of bovine spongiform encephalopathy (“BSE”), commonly referred to as “mad cow disease.” Further, because a head of cattle can be divided into many parts that are shipped to numerous locations, the traceability of each part of one head of cattle can be very difficult. However, because of the guidelines and protocol implemented via the QSA or PVP program, a company exporting beef must trace all beef parts exported and be able to provide documentation of such.

Currently, compliance with the QSA or PVP program requires producers to maintain an extensive amount of documents and other paperwork, and a representative from the USDA must travel to the producers' cites to audit the producers' documents and other paperwork to verify conformance with the QSA or PVP program. This can be costly and time consuming for both the producer and the USDA representative, ultimately driving up the cost of agricultural products.

Accordingly, there is a need for a quality systems assessment program that overcomes the limitations of the prior art.

### SUMMARY OF THE INVENTION

The present invention solves the above-described problems and provides a distinct advance in the art of quality systems assessment (QSA) and product verification (PVP) programs. More particularly, the present invention provides a quality systems management program that is implemented on a computer, wherein a beef producer is able to remotely access and edit required documents, and a USDA representative is able to remotely access the documents to perform audits of the producer's processes.

In a first embodiment, the present invention involves a computer-readable medium encoded with a computer program for enabling a computer to implement a quality systems management documentation program. The computer program includes code segments for receiving and storing information relating to a quality management program implemented by a supplier of commercial products; receiving and storing an electronic document, wherein the document relates to the quality management program and confirms that the management program complies with a government-sponsored quality systems assessment program; and enabling a government representative to selectively view the quality management program information and the electronic document via a remote computer.

In a second embodiment, the computer program includes a code segment for generating a website and selectively providing website access to a quality systems verification program administrator, a plurality of agricultural suppliers, and a government representative. The computer program further includes code segments for providing a quality manual form available via the website, wherein the form is electronic and is remotely editable by the administrator; and generating a quality manual for each supplier by receiving supplier quality management program information from the administrator, combining the quality management program information with information from the quality manual form, and presenting the combined information via the web site.

Another code segment enables the administrator to remotely add an electronic document to each of the quality manuals, wherein each document contains information relating to a quality management program and confirms that at least a portion of the quality management program complies with a government-sponsored quality systems assessment program. Finally, the computer program provides code segments for providing a link from each manual to a document, enabling each supplier to remotely edit a document corresponding to the supplier, and enabling the government representative to selectively and remotely view each of the manuals and the documents.

A third embodiment of the invention involves a method of implementing a quality systems management program. The method comprises the steps of assisting a supplier of commercial products in developing a quality management program for the supplier that complies with a government-sponsored quality systems assessment and product verification program; creating an electronic quality manual containing information relating to the quality management program; preparing an electronic document required by the quality management program and making the document accessible via the manual; and enabling a government representative to remotely conduct a review of the document to verify compliance with the quality systems assessment program.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a flowchart of steps involved in a method of electronically implementing a quality systems verification program according to the principles of the present invention;

FIG. 2 is a flowchart of steps executed by a computer program that implements at least a portion of the quality systems verification program of FIG. 1;

FIG. 3 is a diagram representing a computer network operable to implement the computer program of FIG. 2;

FIG. 4 depicts a control panel that is part of a website created by the computer program of the present invention;

FIG. 5 depicts a QSA program information page of the website of FIG. 4;

FIG. 6 depicts a page of the website of FIG. 4 operable to manage website users;

FIG. 7 depicts a page of the website of FIG. 4 operable to add new website users;

FIG. 8 depicts a page of the website of FIG. 4 operable to edit a portion of the website; FIG. 9 depicts a page of the website of FIG. 4 operable to edit a quality manual form;

FIG. 10 depicts a page of the website of FIG. 4 operable to edit a livestock tag manager page of the website;

FIG. 11 depicts a page of the website of FIG. 4 operable to enable a USDA representative to view information relating to a quality management program of a particular producer;

FIG. 12 depicts a page of the website of FIG. 4 presenting a heading of a quality manual;

FIG. 13 depicts a page presenting an exemplary table of contents of the manual of FIG. 12;

FIG. 14 depicts a page presenting an exemplary references section of the manual of FIG. 12;

FIG. 15 depicts a page presenting an exemplary document control section of the manual of FIG. 12;

FIG. 16 depicts a page of the website of FIG. 4 operable to add a new supplier profile to the website;

FIG. 17 depicts a page of the website of FIG. 4 operable to manage a supplier profile;

FIG. 18 depicts a page of the website of FIG. 4 operable to edit a supplier profile;

FIG. 19 depicts a page of the website of FIG. 4 operable to submit information relating to a supplier's location;

FIG. 20 depicts a page of the website of FIG. 4 operable to manage the allocation of livestock identification tags;

FIG. 21 depicts a page of the website of FIG. 4 operable to import identification tag vendor information;

FIG. 22 depicts a page of the website of FIG. 4 operable to allocate livestock identification tags to a particular producer;

FIG. 23 depicts a page of the website of FIG. 4 operable to generate an identification tag allocation report;

FIG. 24 depicts a page of the website of FIG. 4 operable to remove an allocated identification tag from the computer system;

FIG. 25 depicts a page of the website of FIG. 4 operable to provide a questionnaire to the supplier for evaluating the supplier's ability to verify an age and a source of its commercial product; and

FIG. 26 depicts a page of the website of FIG. 4 operable to provide information to the supplier regarding the criteria for evaluation of the supplier's ability to verify the age and source of its product.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

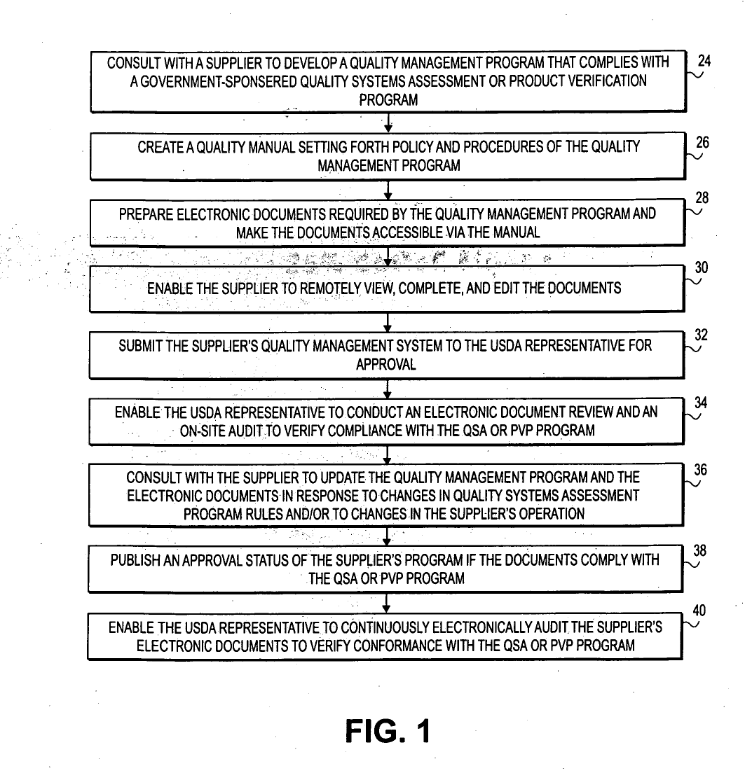

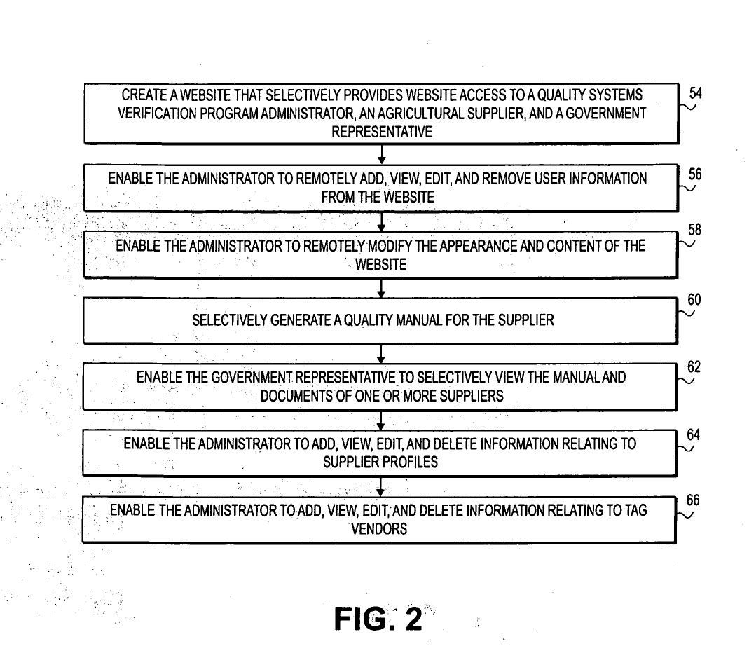

Turning now to the drawing figures, and particularly FIGS. 1 and 2, a method of implementing a quality systems management program (the “management program”) in accordance with a preferred embodiment of the invention is illustrated. The method provides steps for implementing at least a portion of the management program electronically wherein a product supplier can remotely and electronically complete and update management program documents, and a USDA representative can remotely and electronically audit the documents.

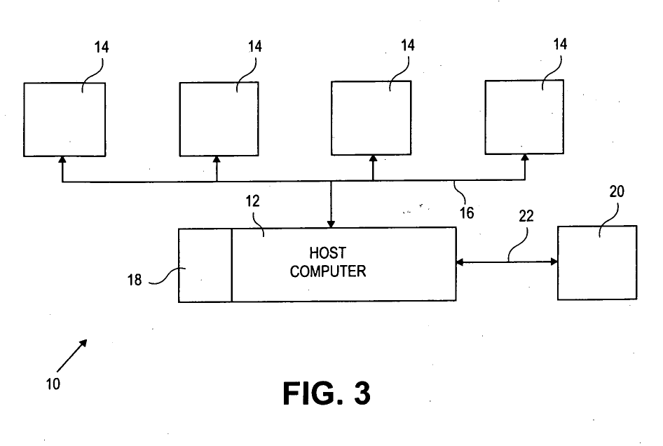

The electronic portion of the present invention can be implemented in hardware, software, firmware, or a combination thereof. In a preferred embodiment, however, the invention is implemented with a computer program that operates a website that is hosted by and can be accessed with computer equipment broadly referred to by the numeral 10 in FIG. 3. The computer equipment 10 includes a host computer 12 and a plurality of computing devices 14 that may access the host computer 12 via a communications network 16. The computer program and equipment illustrated and described herein are merely examples of a program and equipment that may be used to implement the present invention and may be replaced with other software and computer equipment without departing from the scope of the present invention.

The host computer 12 operates or hosts the website of the present invention and serves as a repository for data and programs used to implement certain aspects of the present invention as described in more detail below. The host computer 12 may be any computing device such as a network computer running WINDOWS NT™, NOVEL NETWARE™, Unix, Linux, or any other network operating system. The host computer 12 may be connected to a computing device 18 that serves as a firewall to prevent tampering with information stored on or accessible by the host computer 12 and to a computing device 20 operated by an administrator of the host computer via another communications network 22. The host computer 12 includes conventional web hosting operating software, an Internet connection such as a modem, DSL converter or ISDN converter, and is assigned a URL and corresponding domain name such as “usverified.com” so that the website hosted thereon can be accessed via the Internet in a conventional manner.

The computing devices 14 may be used by agricultural producers and suppliers, USDA representatives, general users such as employees of an agricultural supplier, and others wishing to view and/or edit QSA and PVP program information. The computing devices 14 may be any types of devices that permit access to the host computer 12 via the communications network 16. For example, the computing devices may include personal computers such as those manufactured and sold by DELL™, COMPAQ™, GATEWAY™, or any other computer manufacturer, handheld personal assistants such as those manufactured and sold by Palm or Pilot, or even Internet appliances that are specifically designed for accessing the Internet. Each computing device 14 preferably includes or can access a conventional Internet connection such as a modem, DSL converter, or ISDN converter and a web browser that permits it to access the Internet.

The communications network 16 is preferably the Internet but may be any other conventional communications network such as a local area network, a wide area network, a wireless network, or an intranet. Similarly, the communications network 22 may be a local area network, wide area network, intranet, the Internet, or other conventional network.

The computer program of the present invention is stored in or on computer-readable medium residing on or accessible by the host computer 12 for enabling, instructing, and/or directing the host computer to operate the website of the present invention as described herein. The computer program preferably comprises an ordered listing of executable instructions for implementing logical functions in the host computer 12 and computing devices 14 coupled with the host computer 12. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The flow charts of FIGS. 1 and 2 illustrate the functionality and operation of a preferred implementation of the present invention in more detail. In this regard, some of the blocks of the flow charts may represent a module segment or portion of code of the computer program of the present invention which comprises one or more executable instructions for implementing the specified logical function or functions. In some alternative implementations, the functions noted in the various blocks may occur out of the order depicted in FIGS. 1 and 2. For example, two blocks shown in succession may in fact be executed substantially concurrently, or the blocks may sometimes be executed in the reverse order depending upon the functionality involved.

While at least a portion of the management program of the present invention is implemented electronically, various steps of the program may be partially or completely implemented without electronic assistance. FIG. 1, for example, illustrates an exemplary flowchart of steps involved in implementing the quality systems management program of the present invention, including the step of consulting with a supplier to develop a quality management program for the supplier that complies with a government-sponsored quality systems assessment or product verification program, as depicted in block 24. This step may be wholly executed without electronic assistance, such as where the administrator travels to the supplier's production site and prepares the protocol on paper. Alternatively, this step may be performed partially or completely electronically, such as where the supplier posts production information (e.g., descriptions, photographs, etc.) on a computer network for review. Similarly, various other steps involved in the present invention may be implemented with or without electronic assistance.

The management program of the present invention facilitates interaction among at least three persons or entities: a management program administrator (the “administrator”), a supplier of agricultural products (the “supplier”), and a government representative. The administrator is familiar with the requirements of a USDA-sponsored QSA or PVP program and is skilled at assisting suppliers in developing quality management programs that ensure the suppliers' products meet the requirements of the QSA or PVP program. The administrator further provides a website or other electronically accessible forum for publishing information relating to each supplier's quality management program, as explained below in greater detail. The administrator will typically implement the quality systems management program as part of a business plan, and therefore will charge a fee or will be otherwise compensated for the consulting and web hosting services. While the quality systems management program administrator preferably provides the consulting service, it will be appreciated that such services may be provided by another person or entity, such as a third-party consultant. In many cases, however, it will be most efficient to combine the roles of consultant and program administrator.

The supplier may be any supplier of agricultural products who intends to export one or more of the products to countries that require compliance with the QSA or PVP Program. The supplier is preferably a producer, such as an individual farmer or a corporate farm, who produces agricultural products such as, beef, pork, poultry, fish, grains, fruits, and/or vegetables. The government representative may be any government agent or representative, but is preferably a USDA representative who is familiar with the QSA and PVP programs and the documents required of a producer who applies for QSA or PVP program approval. While the USDA representative is herein referred to as a single person, it will be appreciated that the role of the USDA representative may be filled by more than one person, such as a team of USDA agents or a USDA-accredited body.

Referring particularly to FIG. 1, the supplier first consults with the administrator to develop a quality management program designed specifically to meet the supplier's needs, as depicted in block 24. The program generally is defined by specific policies and procedures to be followed by the supplier and the supplier's employees and agents, wherein the policies and procedures comply with the QSA or PVP program. If the QSA or PVP program requires livestock to be slaughtered at a certain age, for example, the program may include a policy that all livestock be slaughtered prior to that age, as well as procedures for tracking the age of each animal in the supplier's program and recording the age of each animal at the time of slaughter.

The quality management program is thus tailored specifically to the supplier's business according to what products the supplier makes, what facilities the supplier uses, and to which country the supplier intends to export the products. By way of example, the protocol implemented by a beef supplier would be different than a protocol implemented by a poultry supplierora protocol implemented by a pork supplier. Furthermore, the protocol implemented by a beef supplier who sells to customers in Mexico may be different than the protocol implemented by a beef supplier who sells to customers in Japan.

After creating the quality management program, the administrator prepares a quality manual reflecting the policies and procedures of the program, as depicted in block 26. The manual is used by the supplier and the supplier's employees and agents as a reference guide for the day-to-day management of the supplier's business. The manual is periodically reviewed by the administrator to verify conformance with the QSA and PVP programs, and is periodically audited by the USDA representative. Thus, the manual is preferably in electronic form, as explained below, and stored on a computer, such as the host computer 12, such that it is accessible from one or more remote computers, such as the computing devices 14. The manual is preferably stored in the form of HTML files that can be viewed from the remote computers via standard web browsing computer programs. The manual is preferably made available to all relevant employees and agents of the supplier in or near each employee's or agent's work environment to provide quick access to an up-to-date copy of the quality manual. A computer terminal with access to the manual may be made available, for example, at each station of a beef processing plant, in a barn, or even in a vehicle used by the supplier's employees.

The administrator selects and prepares various electronic documents required by the quality management program and makes the documents accessible via the manual, as depicted in block 28. The documents may be selected from a pool of pre-existing document forms and/or may be created anew by the administrator, the supplier, or the USDA representative. The documents are preferably in a format commonly known and accessible by a wide variety of computer users, such as HTML, PDF, MICROSOFT WORD™, or WORDPERFECT™. The documents are preferably accessible from the manual via HTML “links,” as explained and illustrated below, wherein a user browsing the manual can access a particular document by selecting, or “clicking on,” the corresponding link. The documents are preferably stored on the host computer 12, but may alternatively be stored on a remote computer accessible via the computing devices 14.

Once the administrator has selected the documents and includes them in the quality manual, the administrator makes the documents accessible to the supplier via a remote computer so that the supplier can edit and review the documents, as depicted in block 30. This may be done, for example, by giving the supplier special access rights to the documents via the website. Thus, the administrator will typically merely select the documents and make them available to the supplier for the supplier to edit and complete at the supplier's convenience, as the supplier will usually have the easiest access to the information needed to complete the documents. Alternatively, the administrator may populate the documents with generic pieces of information, such as the supplier's name and contact information.

Once the manual and the documents have been completed and made accessible via a remote computer, the supplier submits the manual to the USDA representative for approval, as depicted in block 32. This may involve, for example, preparing a brief application, either in paper or electronic form, and sending the application to the USDA representative.

The USDA representative then conducts a document review and on-site audit to verify compliance with the QSA or PVP program, as depicted in block 34. The USDA representative first conducts a preliminary desk audit, or document review, by accessing and viewing the quality manual and the documents to verify that the policy and procedures set forth in the manual conform to the QSA or PVP program. The document review can be performed electronically and/or remotely, such as from the representative's office via the Internet, and thus can save the time and expense of traveling to the supplier's production site and/or managing paper documents. If the USDA representative discovers program policies, procedures, or documents that do not comply with the QSA or PVP program, he or she can take corrective actions such as requesting further documentation or requiring a change in the quality management program or the quality manual. Such corrective action may be performed electronically or without electronic assistance.

After verifying that the policies and procedures set forth in the manual conform to the QSA or PVP program, the USDA representative conducts an on-site audit to verify that the supplier's actual operations conform to the policies, procedures, and documentation set forth in the quality manual. Once the USDA representative is satisfied that the supplier has passed the initial audits and that the supplier's operations comply with the QSA or PVP program, the USDA representative approves the supplier's program, as explained below in greater detail.

After the initial approval process, the supplier and the administrator continue to work together to update the supplier's quality management program, the quality manual, and the related documents, as depicted in block 36. Such updates may be needed, for example, as the QSA Program rules change, as the supplier's business changes, or both. The supplier contacts the administrator, for example, to report any changes in the supplier's business plan or business operations. If the supplier plans to export grain and beef, but was initially approved to export beef only, the supplier conveys that information to the administrator. The administrator then consults with the supplier to determine what changes or additions need to be made to the supplier's quality management program to reflect the new business plan. The administrator then updates the manual and the documents to reflect any changes in the quality management program and advises the USDA representative of the changes.

The process of updating the quality manual and the documents may further be facilitated by automatically generating notices or similar communications between the interested parties. A computer may be programmed to monitor the documents, for example, and automatically send an e-mail or other notification to the administrator, the USDA representative, or both when the supplier makes any changes to the document. Furthermore, the computer may automatically send an e-mail or other notification to the USDA representative when the administrator makes any changes to the manual. Additionally, the computer may send automated notices only when certain portions of the documents or the manual are updated. Updating a phone number of a web site user may not trigger a notification, for example, whereas submitting a new document would trigger a notification. Finally, the computer may enable the USDA representative, the administrator, or both to indicate which portions of the documents or manuals will trigger an automatic notification when changed.

Once the supplier's quality management program, quality manual, and documents have been approved, an approval status of the supplier is published, as depicted in block 38. The approval status will typically be published by the USDA representative electronically via the Internet so that importers from various countries can quickly and easily confirm that the supplier is certified by simply logging onto a website maintained by the USDA. The administrator preferably includes links to a USDA website that includes lists of approved suppliers and/or maintains similar lists on the administrator's website.

The USDA representative periodically audits the supplier's quality management system by verifying that the policies and procedures set forth in the quality manual and in the documents conform to the QSA or PVP program, as depicted in block 40. Finally, the USDA representative periodically performs on-site audits of the supplier's operation to verify conformance with the quality policies and procedures set forth in the quality manual and the documents.

At the heart of the above-described process is a computer program that facilitates one or more of the process steps by implementing the step electronically. In its preferred form, the computer program provides an electronic verification method adapted specifically for use by a beef supplier. It will be appreciated, however, that the program may be used with other agricultural products, such as pork, poultry, grain, vegetables, and non-food products such as leather and wool, wherein exports must meet certain criteria and production processes and methods must be documented.

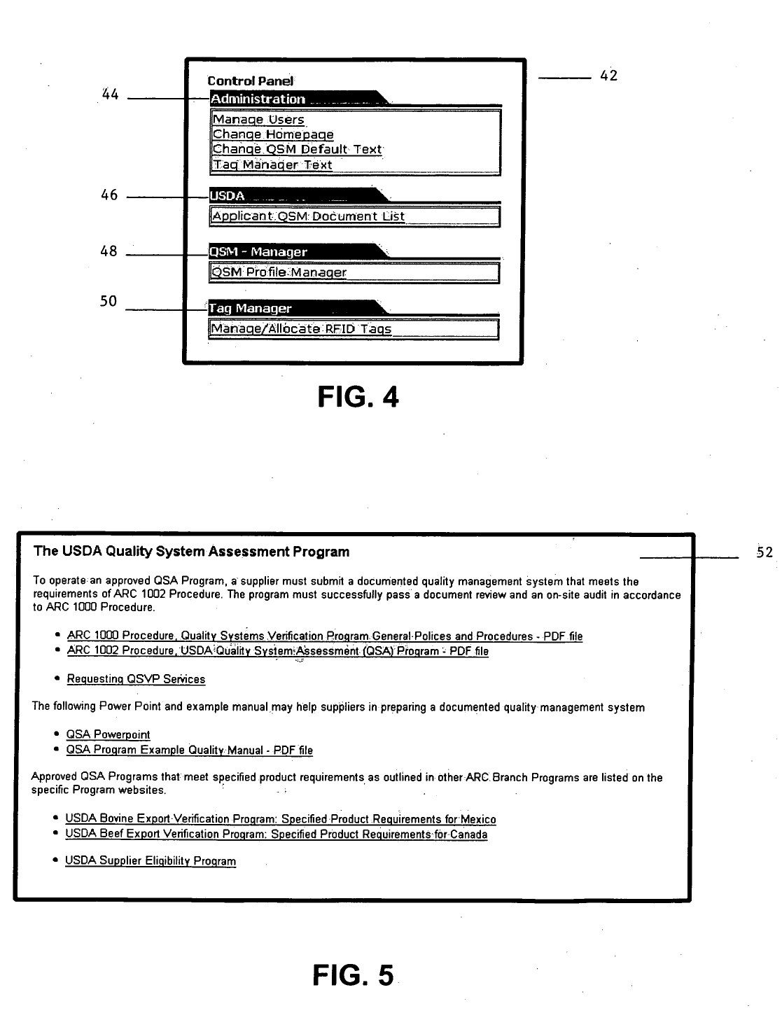

The computer program is operable to establish a web site accessible to various parties. A home page provides an overview of the website and guides website users by providing information about the site as well as links to particular pages within the site. Referring to FIG. 4, an exemplary home page includes a control panel 42 that provides links to various other portions of the website, wherein the links are categorized, for example, according to the website user or users served by the links. The “Administration” portion 44 of the control panel 42 includes links to pages within the website that enable the administrator to manage the site. The “USDA” section 46 of the control panel generally provides one or more links to pages that enable a USDA representative to review and audit documents related to a supplier's business to ensure compliance with the QSA or PVP program. The “QSM—Manager” section 48 of the control panel generally provides one or more links to pages that enable a user to view and manage information relating to supplier files. The “Tag Manager” section 50 of the control panel generally provides one or more links to pages that enable a user to view and manage information relating to livestock tags.

The home page also includes a “QSA Program Information” section 52 as illustrated in FIG. 5. The QSA Program Information section 52 generally provides a description of the USDA QSA or PVP program and/or links to documents relating to the QSA Program, and further includes such information as the procedure for enrolling in the quality systems management program offered by the administrator.

The home page is made available to selected users via, for example, a log-in screen that requires each user to submit a user name and a password to gain access to the home page. Requiring each user to log in enables the program to recognize the types of users that are using the system and grant access to select portions of the web site accordingly. The administrator, for example, may be granted access to the entire web site while the USDA representative may be granted access to only a portion of the website, such as the portion defined by the “USDA” section 46 of the control panel.

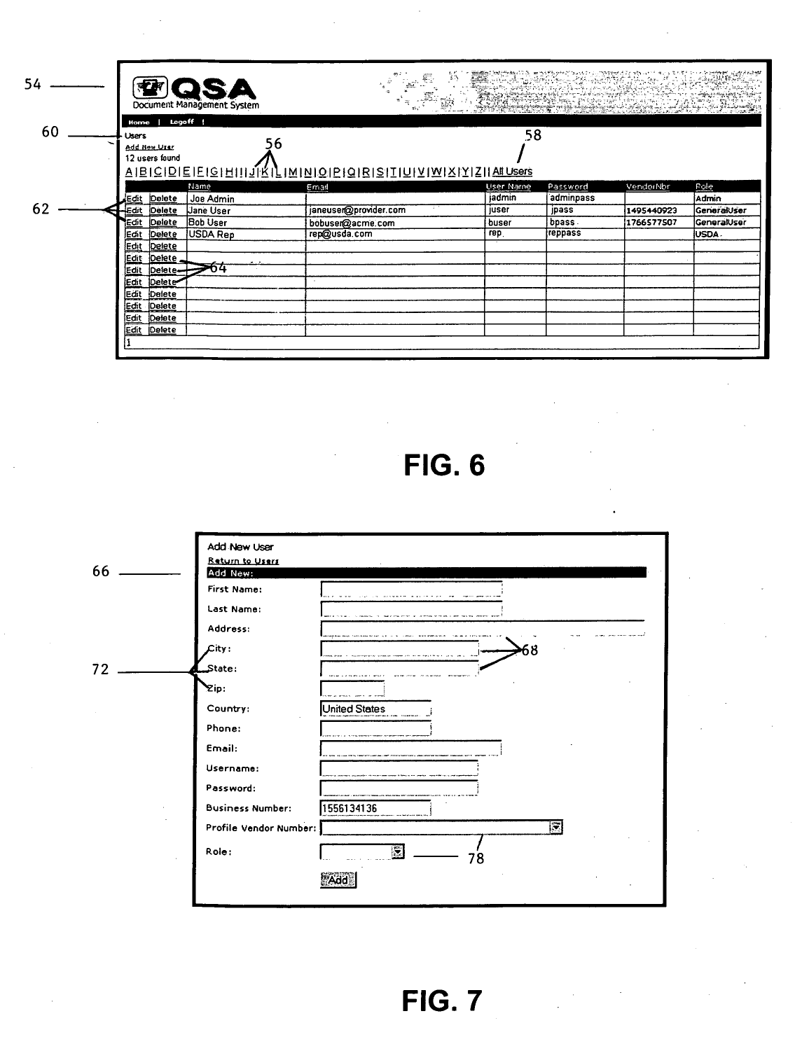

The computer program enables the administrator to add, view, edit, and remove user information from the website, as depicted in block 54 of FIG. 2. Referring again to the control panel of FIG. 4, and particularly the “Administration” section 44 of the control panel, a “Manage Users” link links to a page that enables the administrator to add, edit, manage, and delete information relating to users of the website. An exemplary user management page interface 54 is illustrated in FIG. 6, wherein website users are categorized according to last name, and letters 56 representing first letters of last names each provide links to pages with information about the user's whose last name begins with that particular letter. The interface also provides a link 58 that enables the administrator to view all users on a single page as opposed to according to last name.

The user management page further includes links 60,62,64 to pages that enable the administrator to add, edit and/or delete information relating to each user, respectively. Clicking on the “Add New User” link 60, for example, would request a page that allows the administrator to submit information relating to a new user. A portion of an exemplary new user page 86 is illustrated in FIG. 7, wherein the page includes a plurality of text fields 68 for submitting text and drop-down boxes 70 for choosing one or more pieces of information from a pre-defined list of options. Identifiers 72 corresponding to each text field and drop-down box indicate the type of information to be submitted in the corresponding text field or drop-down box. One or more pieces of information may be automatically placed in the page when the page is loaded onto the user's computer, which may be particularly useful where the information is already known (e.g., a business number already submitted by the user or automatically assigned by the program) or is common to most users (e.g., country of origin).

Clicking on an “Edit” link 62 of the user management page interface 54 corresponding to a user requests an edit user page that is substantially identical to the new user page described above, except that the edit user page automatically fills in various text fields and drop-down boxes with user information that was previously submitted. Furthermore, clicking on a “Delete” link 64 corresponding to a user causes the computer to delete all information relating to the corresponding user. Such an action could be harmful to the operation of the system if performed unintentionally, therefore the program preferably implements one or more safeguards to prevent inadvertent deletion of information such as, for example, a message that asks the administrator to confirm the delete request, to re-submit a username and password, or both.

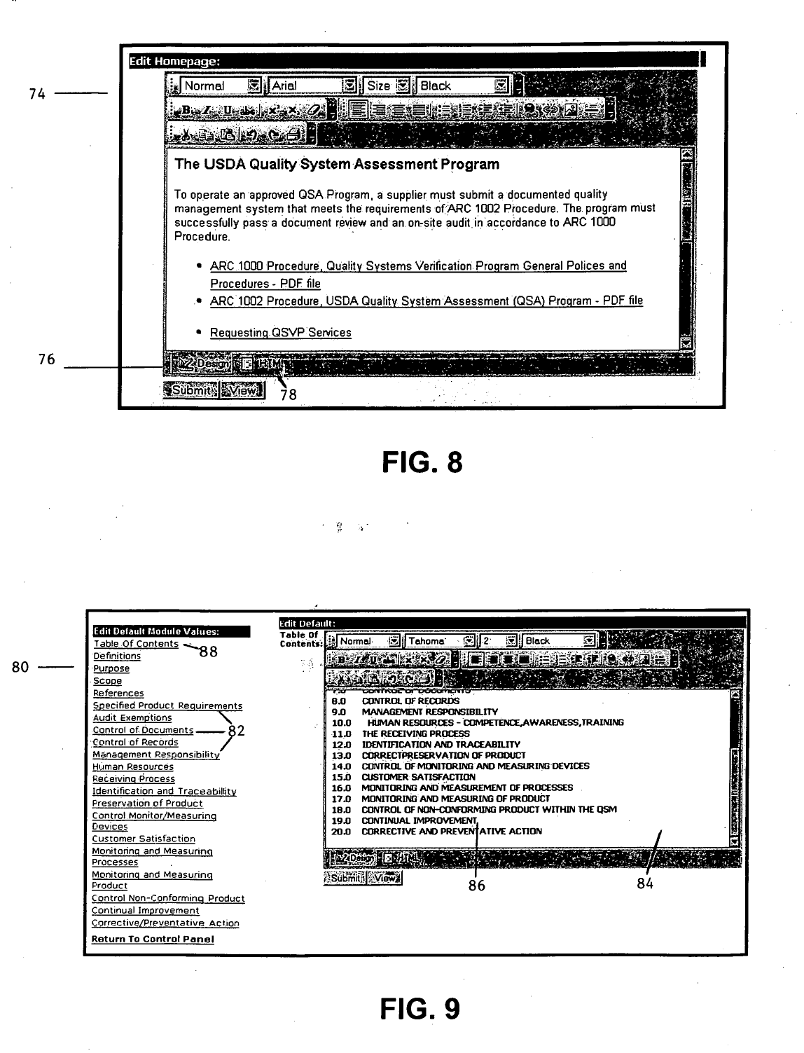

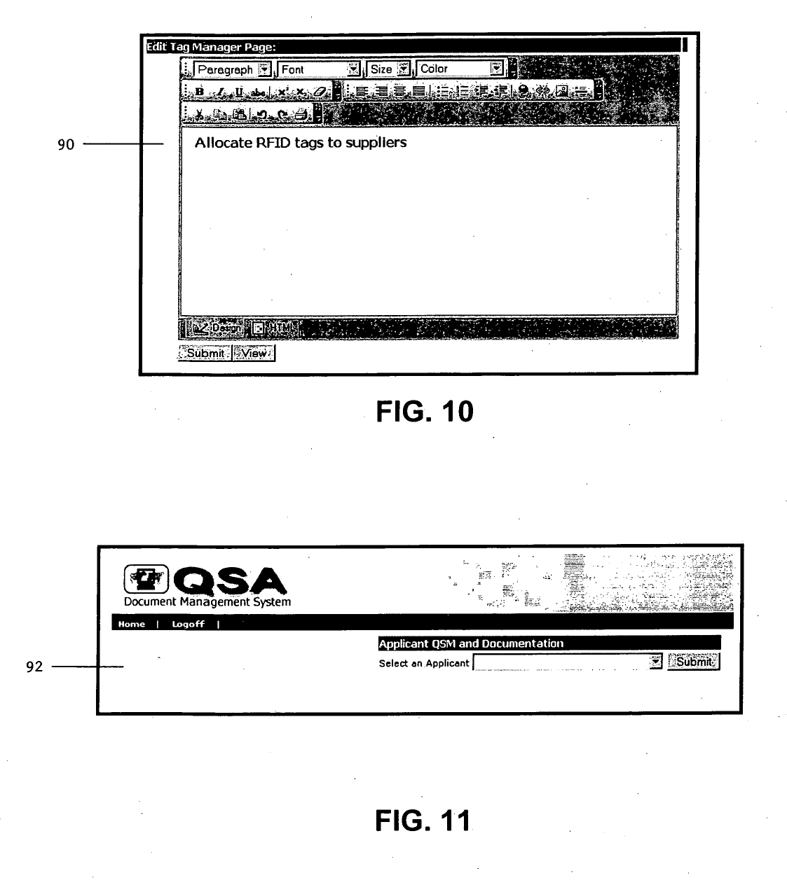

The computer program enables the administrator to remotely modify the appearance and content of various pages of the website. The “Change Homepage” link of the control panel 42, for example, links to an editor page 74 that enables the administrator to change the look and content of the home page. Such an editor page may present an HTML editor similar to the one presented in FIG. 8, wherein the administrator can modify the content of the home page by adding or changing the text, images, and/or links. Furthermore, the administrator can change the look of the home page by modifying, for example, the type, size, color, and justification of font. The editor presents two or more views, such as a design view for allowing the administrator to view the homepage as it will appear in a browser, and an HTML view for allowing the administrator to view and manipulate the HTML source code corresponding to the home page. These views are preferably alternatively presented according to the selection status of alternative tabs 76,78, as illustrated in FIG. 8. The views may also be presented simultaneously in a side-by-side or above-and-below fashion.

The computer program enables the administrator to view and edit a default appearance and default content of a quality manual form. The “Change QSM Default Text” link of the administration section 44 of the control panel 42, for example, links to a manual form editor page 80 illustrated in FIG. 9. The manual form editor page 80 enables the administrator to change the default look and content of various modules of a quality manual form used by a supplier to create an on-line procedure manual for implementing the quality management program. In the exemplary editor page 80 of FIG. 9, a plurality of modules 82 are shown on the left and an editor portion 84 is shown on the right. Clicking on a module on the left causes default text relating to that module to appear in the editor portion for editing. In FIG. 9, for example, default text 86 relating to a table of contents appears in the editor portion 84 after the “Table of Contents” link 88 of the module list has been selected. The editor portion 84 of the QSM editor page is substantially identical to the editor portion of the home page editor page 74 described above. The quality manual is described below in greater detail.

The computer program enables the administrator to view and edit default appearance and contents of a tag manager. The “Tag Manager Text” link of the control panel 42, for example, links to a tag manager editor page 90 that enables the administrator to change the look and content of a tag manager. The tag manager editor page 90 includes an editor portion that is substantially identical to the editor portion of the home page editor page described above and illustrated in FIG. 8.

The tag manager facilitates the distribution and allocation of animal identification tags by allowing suppliers to order the tags through the quality systems management program. The administrator, for example, collects information relating to one or more identification tag vendors, such as tag product information and pricing information. A supplier could then view the information and place an order via the website, thus obviating the need for the supplier to personally collect the tag vendor information. The administrator could then place the order for the tags, or could simply forward the order information to the tag vendor. In the latter scenario, the vendor would be working directly with the supplier and the website would function simply to facilitate the transaction between the two.

The computer program generates a quality manual for one or more suppliers, as depicted in block 60 of FIG. 2. The computer program combines quality management program information, documents, and information from the quality management form to generate each quality manual. The administrator preferably controls when each manual is generated via a portion of the website inaccessible to other users. Once a quality manual is created, its contents may be made accessible to one or more users of the web site. The contents of the quality manual are described below in greater detail.

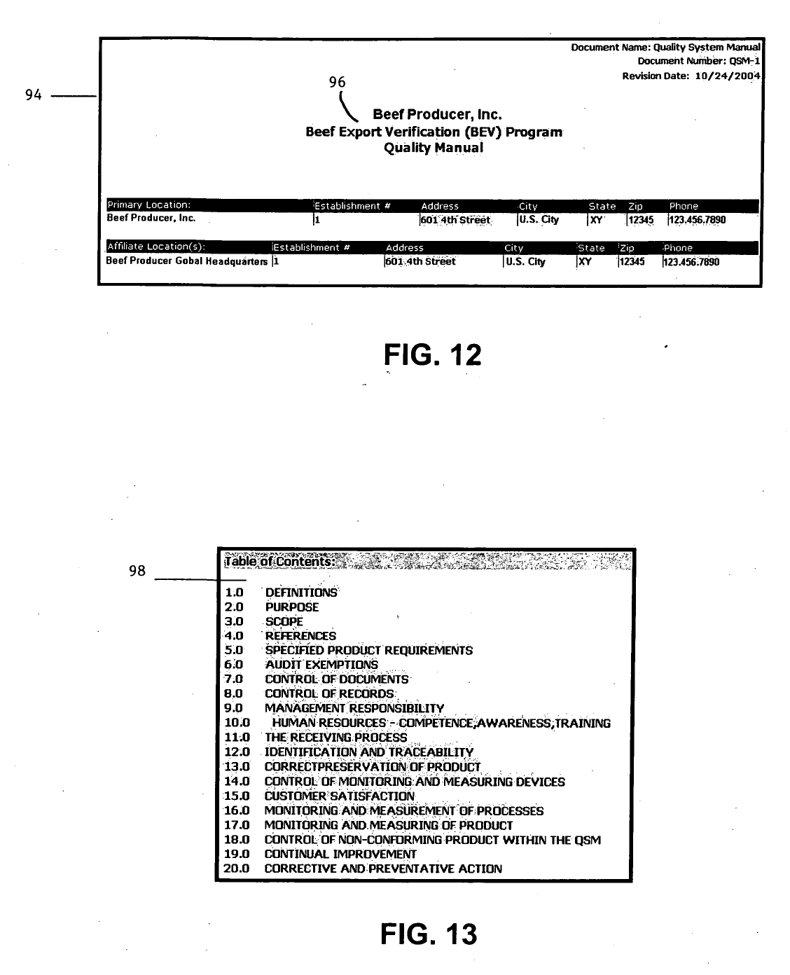

The computer program enables the USDA representative to selectively view the quality manual and documents of one or more suppliers, as depicted in block 62 of FIG. 2. The illustrated USDA section of the control panel 42, for example, includes an “Applicant QSM Document List” link that requests a page 92 that allows the USDA representative to choose a particular supplier to audit, as illustrated in FIG. 11. Choosing a supplier requests a quality manual page that includes protocol, documents, or both relating to that supplier's production process. A portion of an exemplary quality manual page 94 is illustrated in FIG. 12, wherein a heading of a quality systems manual is illustrated. The heading includes a title portion 96 with a name of the supplier, as well as a supplier information portion that includes an address of the supplier and/or one or more of the supplier's affiliates. The heading is preferably at the beginning of the manual or other location where it will catch the attention of a user reading the manual.

A table of contents follows the heading, wherein an exemplary table of contents 98 is illustrated in FIG. 13. It will be noted that the table of contents 98 illustrated in FIG. 13 is substantially identical to the table of contents of the manual form editor page illustrated in FIG. 9. Thus it can be seen that the quality systems manual is created from a form that is generated automatically by the computer program, wherein the computer program generates the manual with sections corresponding to each of the modules illustrated in FIG. 9 and with default content that corresponds to the content of the editor portion of QSM editor page of FIG. 9. The various sections and contents of the quality systems manual (“the manual”) will now be discussed in greater detail. The manual generally sets forth policies and procedures of the supplier's quality management program, and provides documents that are required by the program and that are necessary for auditing purposes. The manual is an electronic document that may be read and displayed by a computer, and is preferably an HTML file that includes links to the documents. The manual includes various standard sections as set forth in the table of contents 98 illustrated in FIG. 13. As explained above, each of these sections includes default textual content that may be altered by the administrator as the administrator customizes the manual to reflect the policies and procedures of the supplier's quality management program.

The definitions section of the manual generally includes definitions of terms or phrases appearing in the manual that are susceptible of being assigned a meaning other than that intended by the administrator and/or the supplier. Terms or phrases that are ambiguous or that have been used according to a very narrow meaning, for example, may be defined in the definitions section. The purpose section of the manual generally sets forth the purpose of the manual which may be, for example, “to establish, document, implement and maintain a quality management system which ensures the products conform to the USDA, Agricultural Marketing Service, Audit, Review and Compliance (ARC) Branch, ARC 1002 Procedure, Quality System Assessment (QSA) Program, dated Mar. 4, 2004.”

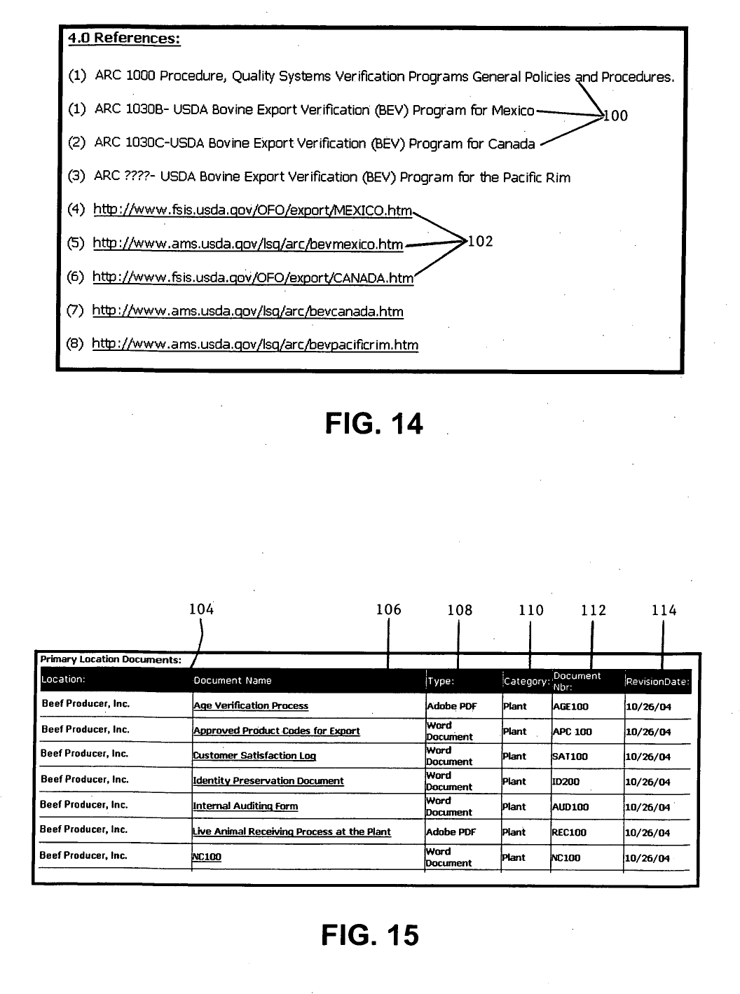

The scope section of the manual generally describes a scope of the supplier's business, and may include a statement such as “Beef Supplier, Inc. slaughters, fabricates, processes, grinds and sells fresh beef and beef products to domestic and international customer.” The scope section may further include other details of the supplier's business, such as location and quality goals. The references section of the manual generally lists and/or provides links to government documents or other publications relating to the supplier's business. An exemplary references section is illustrated in FIG. 14, including a list of various government documents 100 and providing links 102 to one or more of those documents. Linking a list entry to the corresponding document is particularly useful where the document is maintained in electronic form on a computer network, such as the Internet, so that a user can quickly and easily access the most current form of the document.

The specified product requirements section of the manual generally outlines the requirements set forth by the USDA relating to the supplier's business. The specified product requirements section may include, for example, a minimum and maximum age of animals from which beef products can be produced; whether imported beef products may be resold; and identification requirements including any documentation required to accompany shipped beef products. The specified product requirements section may further include a link to one or more documents relating to the product requirements.

The audit exemptions section generally explains portions of the supplier's business that are beyond the scope of USDA audits. The animal detention process and the control of specified risk materials, for example, may not be regulated by the USDA and therefore may be listed as an audit exemption. The control of documents section of the manual generally includes information relating to how QSM documents are controlled. The section may include such information as which documents are controlled, who controls them, and what identification may or shall appear on each document—such as document name, document number, and document revision date.

Referring now to FIG. 15, the control of documents section preferably includes a document list that provides a link to an electronic form of one or more of the documents. The list includes several pieces of information relating to each document, including a location 104 of the document, wherein the location may include where an electronic copy of the document is maintained and/or where a hard copy of the document is stored; a document name 106, wherein each document name provides a link to an electronic form of the respective document; a document type 108; category 110; document number 112; and revision date 114. The document list illustrated in FIG. 15 is designated as including only primary location documents. One or more additional lists may be included in the control of documents section that include, for example, location specific documents that are not stored or maintained at the primary location.

The control of records section of the manual generally explains where records relating to the supplier are to be stored. It may explain, for example, where and for how long historic corporate records and department specific records are stored. It may further explain a procedure for storing and retrieving records. This section of the manual serves to facilitate the auditing process by giving the USDA quick and easy access to supplier records necessary to perform an on-site audit. Similarly, the management responsibility section of the manual generally explains the role of a management representative or management team and lists who the representative is or who comprises the management team.

The manual section entitled “human resources—competence, awareness, and training” generally explains the policy and procedures for training employees to work according to quality protocols set forth in the quality system manual. This section explains, for example, to what quality standards employees are held; how employees are trained; how employee training is documented; and how employees are monitored to ensure compliance with the quality system protocols. This section may further include lists of and/or links to documents that set forth any of the above. It may include a link, for example, to a document setting forth quality standards and procedures in a particular area such as carcass segregation by age.

The receiving process section of the manual generally explains the policy and procedures relating to receiving products that are used in production. More particularly, this section may set forth procedures relating to the segregation, identification, and documentation of products received into a processing plant. This section may further provide a list of and/or links to various documents relating to the receiving process, such as a document setting forth an age verification process.

The identification and traceability section of the manual explains policies and procedures adopted by the supplier to ensure product identity is maintained and traceable throughout the production, packaging and labeling processes. This section may explain, for example, how animal age is determined; how an animal source is determined and documented; how identities of products produced from animals of different ages are retained during the harvesting and fabrication processes; and how products from different age groups are to be labeled and documented. This section may also include a list of and/or links to documents relating to identification and traceability of products, such as document(s) setting forth an age verification process. The identification and traceability section will be described in more detail below with respect to evaluating and assessing a supplier's verification of an age and source of a product.

The preservation of product section generally explains how products are maintained to preserve conformity with the quality program throughout production and until the product is delivered. The control and monitoring of measuring devices section generally explains policy and procedures relating to measuring devices used to verify that products are conforming to required quality standards. The customer satisfaction section of the manual generally explains how the supplier monitors customer satisfaction levels to ensure customer expectations regarding the quality program are being met. This section may explain, for example, how customer satisfaction is measured, how it is recorded, and how it is communicated to various employees and/or representatives of the supplier. This section may include a list of and/or links to documents relating to customer satisfaction, such as a customer satisfaction log.

The monitoring and measurement of process section of the manual generally sets forth how the supplier will monitor the effectiveness of the supplier's process or processes in meeting the product quality standards established by the USDA and expressed in USDA regulations and the supplier's protocol. This section may set forth, for example, who will perform the monitoring and how often the process will be monitored. It may further explain a procedure for responding to portions of the supplier's process that are discovered not to conform to the quality requirements. This section may further include a list of or links to documents relating to the monitoring and measurement process, such as auditing forms or process description documents.

The monitoring and measurement of product section of the manual generally sets forth how the supplier will monitor the products produced by the process to ensure they conform to the standards established by the USDA and expressed in USDA regulations and the supplier's protocol. This section may set forth the procedure for verifying that products produced by process conform to the standards, such as how products are sampled. This section may further include a list of and/or links to documents relevant to product monitoring and measurement.

The control of non-conforming product within the QSM section of manual generally explains how the supplier will respond if a non-conformance to the QSA program is identified. This section may explain, for example, what specific actions are to be taken and who has authority to take those actions. This section may further include a list of and/or links to documents relevant to control of non-conforming product.

The continual improvement section of the manual generally sets forth policy and procedure for continuously improving the supplier's process so that the process better enables the supplier to produce products that conform to the product standards established by the USDA. This section may set forth, for example, how deficiencies in the process are ascertained, how improvement procedures are designed, who decides which improvement procedures are implemented, and/or how improvements are documented. This section may further include a list of and/or links to documents relevant to the continual improvement process, such as internal audit forms.

The corrective and preventive action section of the manual generally explains policy and procedure for taking action in response to an identified or anticipated non-conformance. This section may explain, for example, what changes to policy, procedures, documentation and employee training will occur in response to an identified non-conformance. This section may further include a list of and/or links to documents relevant to corrective and preventive action procedure and policies, such as internal auditing documents.

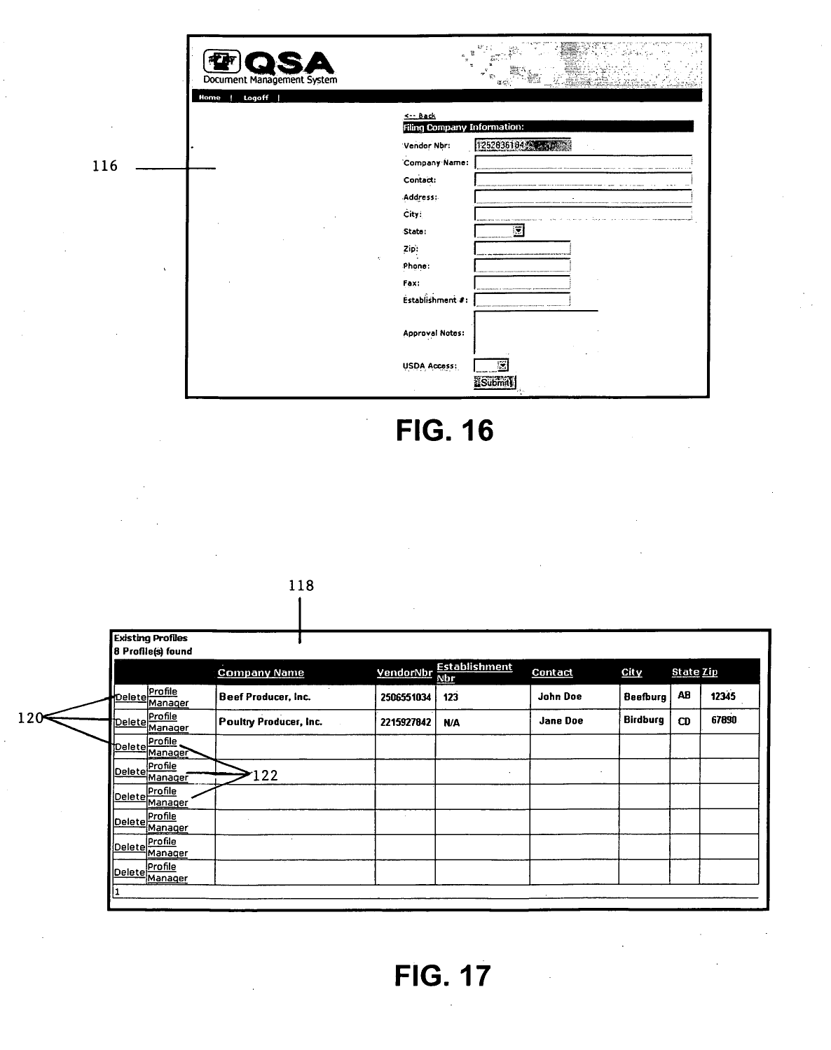

The “QSM—Manager” section of the control panel 42 generally provides one or more links to pages that enable a user to view and manage information relating to supplier profiles. Clicking on the “QSM Profile Manager” link requests a page that allows the user to create a new profile or edit one or more existing supplier profiles. Choosing to create a new profile requests a new supplier profile page that presents a plurality of text fields and/or drop-down boxes for submitting information relating to the new profile. An exemplary new supplier profile page 116 is illustrated in FIG. 16, wherein the page allows the user to submit information relating to a vender number; a supplier company name; a contact; address and telephone information; establishment identification; supplier approval notes; and whether or not a USDA representative has access to the supplier profile information.

Choosing to edit an existing profile invokes an edit supplier profile page that includes a list of supplier profiles, wherein each profile may be edited or deleted. An exemplary edit supplier profile page 118 is shown in FIG. 17, wherein the list of profiles is included in a table such that each row in the table is dedicated to a supplier and includes columns for supplier company name, vender number, contact person, city, state, and zip code of each supplier. A “Delete” link 120 corresponding to each profile is included in each row, wherein clicking on the Delete link generates a message seeking confirmation of the user's desire to delete the corresponding profile. Finally, a “Profile Manager” link 122 corresponding to each profile is included in each row, wherein clicking on the Profile Manager link requests a profile manager page.

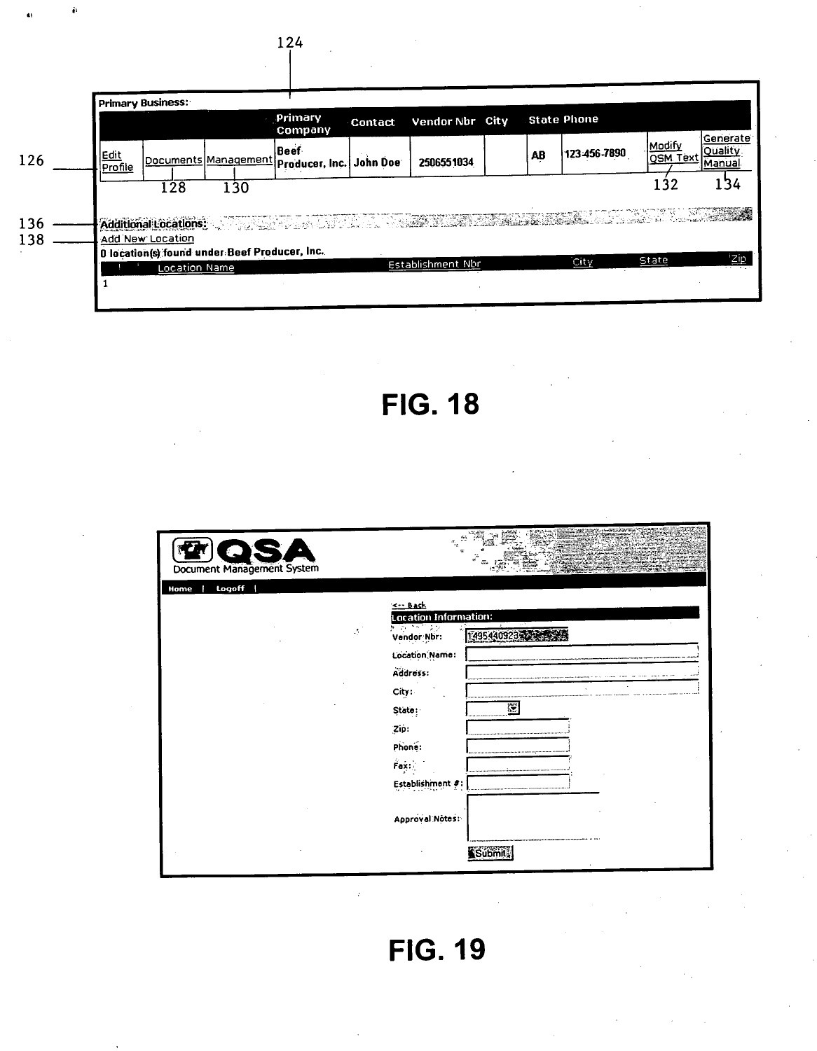

Clicking on the “Profile Manager” link requests a profile manager page that enables the user to manage information relating to a particular profile. An exemplary profile manager page 124 is illustrated in FIG. 18. The profile manager page 124 includes various fields of information relating to the supplier's profile, such as the primary company of the supplier; the supplier contact person; vendor number; address information; and phone number information. The profile manager page further includes various links to pages that enable the user to add, modify, and delete information relating to the supplier's profile. The “Edit Profile” link 126, for example, invokes an edit profile page that is substantially identical to the new profile page illustrated in FIG. 15, except that the edit profile page pre-fills various text fields and/or drop-down boxes to reflect the current information pertaining to the supplier's profile. The “Documents” link 128 links to a supplier document page that provides a list of and/or links to all of the documents associated with the supplier's profile. The “Management” link 130 links to a supplier management page that provides a list of persons associated with the management of the supplier. The “Modify QSM Text” link 132 links to the manual editor, illustrated in FIG. 8 and described above. Finally, clicking on the “Generate Quality Manual” link 134 causes the computer program to generate the quality manual and invoke the quality manual page so that the user can immediately view the manual.

The profile manager page further includes a section 136 denoted as “additional locations” that presents information relating to alternative locations of the supplier. Included in the additional locations section is an “Add New Location” link 138 that links to an add new supplier location page. An exemplary portion 140 of an add new supplier location page is illustrate in FIG. 19, wherein the page includes various text fields for submitting information relating to the new location.

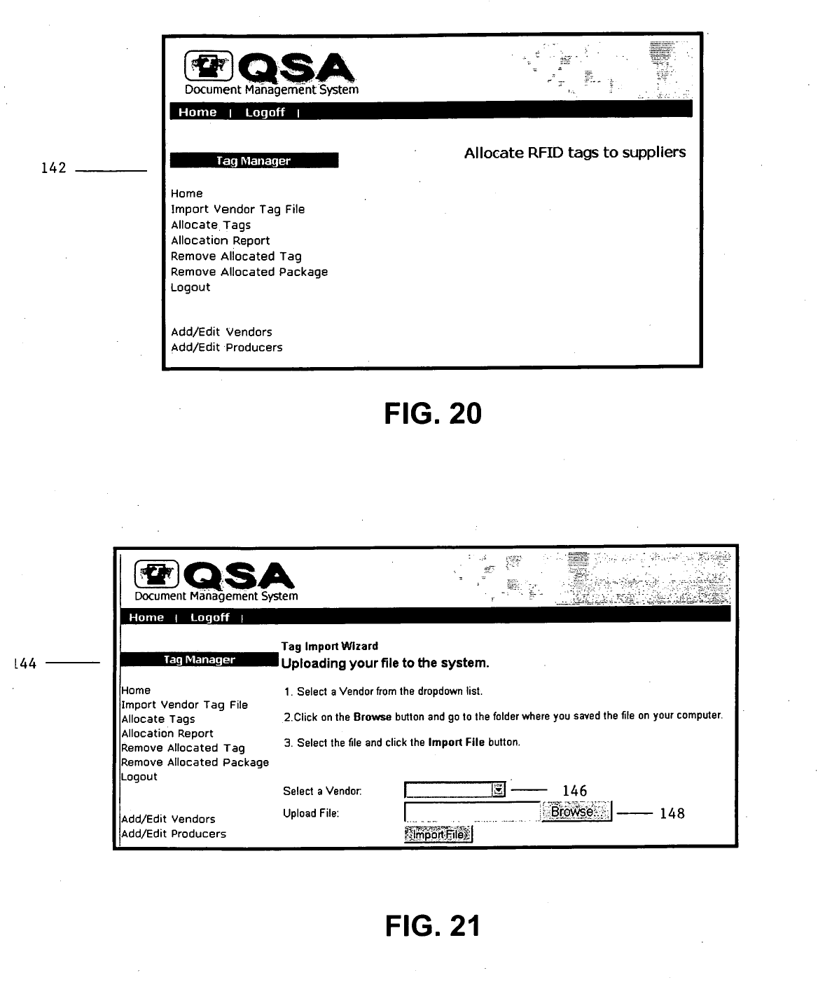

The “Tag Manager” section of the control panel 42 generally provides one or more links to pages that enable a user to view and manage information relating to livestock tags. An exemplary tag manager page 142 is illustrated in FIG. 20, wherein the tag manager page 142 generally provides links to various functions relating to importing vender tag information and allocating tags to suppliers.

An exemplary allocate tags page 144 is illustrated in FIG. 21. The allocate tags page enables a user to upload information relating to tags distributed by a particular tag vendor. The allocate tags page includes, for example, a drop-down box 146 presenting a list of vendors a user can choose from as well as a browse button 148 for initiating a search for files relating to a selected vendor.

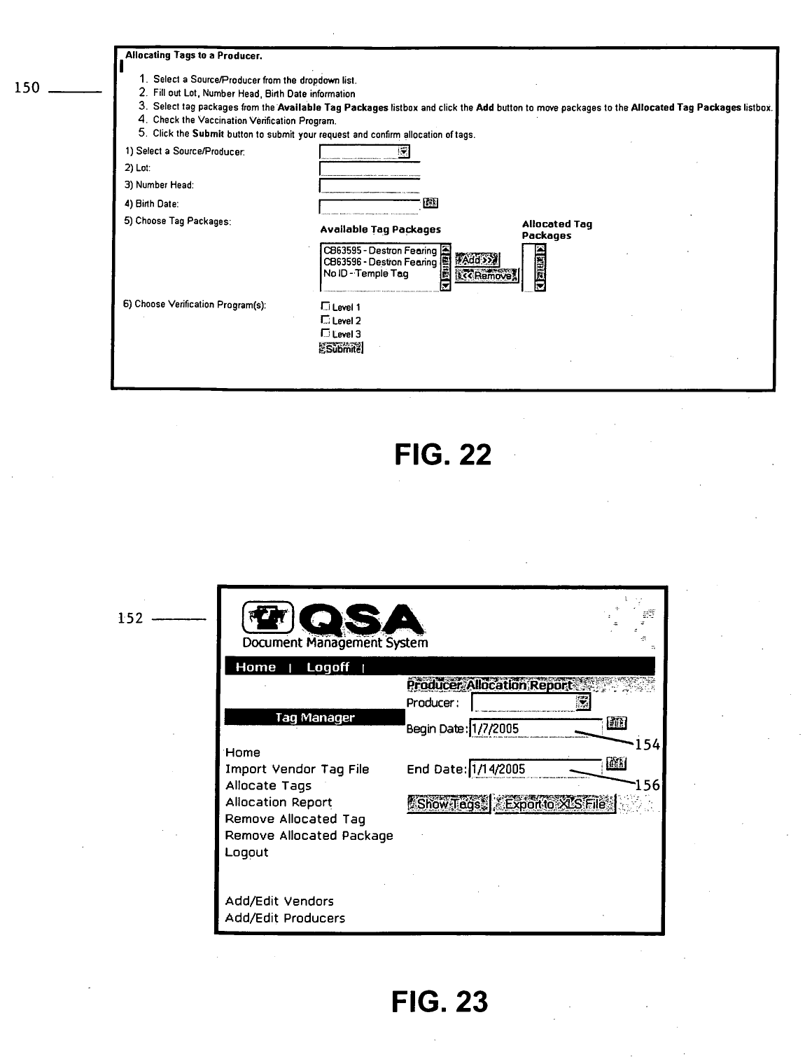

An exemplary allocate tags page 150 is illustrated in FIG. 22. The allocate tags page generally allows a user to allocate tags, such as tags indicated by the vendor tag information described above, to particular suppliers or particular animals. More particularly, the allocate tags page enables the user to choose a supplier and group of animals according to lot, number head and birth date. The user then may allocate a tag package to the group of animals. An allocation report page 152, illustrated in FIG. 23, allows the user to generate a report relating to the allocation of tags during, for example, a period of time defined by a begin date 154 and an end date 156. The allocation report page 152 allows the user to view an electronic report or export the report to any of various file formats, such MICROSOFT EXCEL™ format.

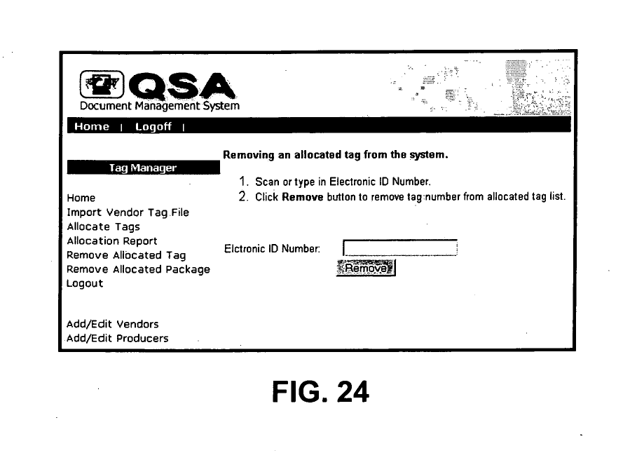

Previously allocated tags may be removed from the system using, for example, a remove allocated tag page 158 illustrated in FIG. 24. The remove allocated tag page 158 allows a user to choose a tag according to an electronic identification number and remove the tag from the system. An exemplary remove allocated package page would be similar to the remove allocated tag page illustrated in FIG. 23, except that it would prompt the user to submit a package number instead of an Electronic ID Number.

Furthermore, the computer program enables the administrator to add new tag vendors and edit information relating to existing tag vendors, as indicated by the links in the tag manager page 142 illustrated in FIG. 20. An exemplary edit vendors page would be similar in appearance and function to the user management page 54 illustrated in FIG. 6, and an exemplary add new vendor page would be similar to the add new user page 66 illustrated in FIG. 7. Similarly, an exemplary edit suppliers page would be similar to the user management page 54 illustrated in FIG. 6, and an exemplary add new supplier page would be similar to the add new user page 66 illustrated in FIG. 7.

With respect to the identification and traceability section of the manual, the section further includes a module for evaluating and assessing a supplier's ability to verify an age and a source of a commercial product sold or otherwise produced by the supplier. The age and source of a product are often components of a QSA or PVP program, and as such, the age and source must be verified. The verification is preferably completed by the administrator, and the verification is made accessible to the USDA representative or other government representative via the website.

The age of a product may be the age the product was made or harvested, such as for plant products, or the date of birth of the product, such as for animal products. The source of the product may be a farm where a plant product was harvested or a processing plant where a plant product was processed, or the source may be a ranch or farm where an animal product was reared or a slaughter house where an animal product was slaughtered.

The computer program allows for initially evaluating the supplier's ability to verify the age and source of its products. This initial evaluation comprises receiving and storing information regarding the age and source of the products, including providing the supplier an initial questionnaire to be answered by the supplier and related to product handling and dating and an extent to which the supplier can provide supporting documentation for the age and source of the products; based on the information received, assessing the supplier's ability to provide products meeting minimum product verification requirements, wherein the assessment may be based on the information provided, or, alternatively, the assessment may be based on an on-site evaluation of the supplier; and should the supplier provide products that meet the minimum product verification requirements, identifying the supplier as an approved supplier. Once approved, the supplier is assessed on a periodic basis, such as yearly, to ensure the supplier is continuing to provide products meeting the minimum product verification requirements.

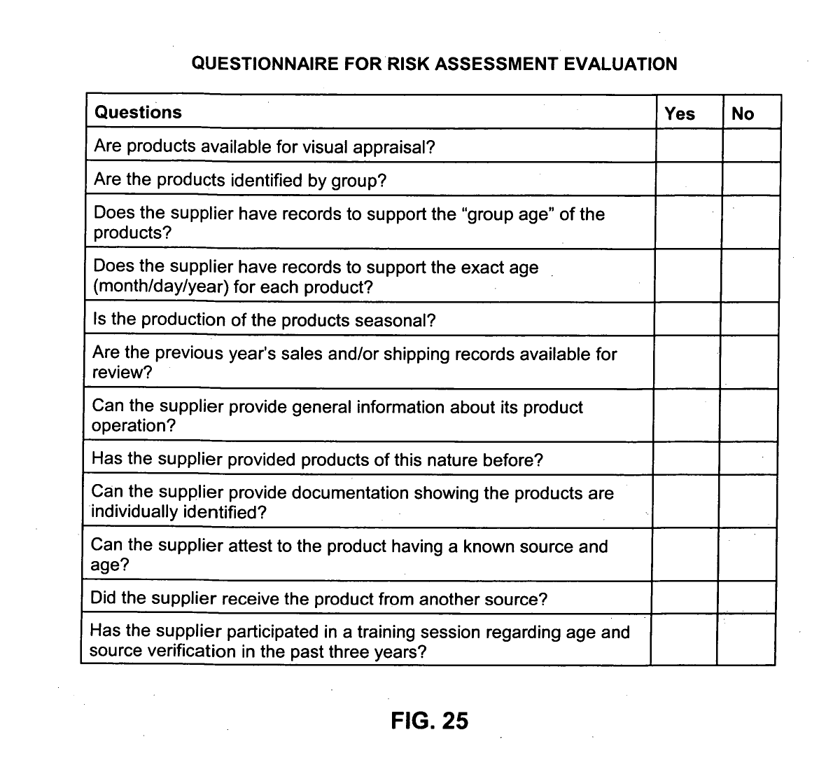

The initial evaluation and receiving of information may comprise many forms but preferably includes providing a questionnaire to the supplier that assesses the supplier's method of business operation and further receiving supporting documentation for the age and source of the products, as illustrated in FIG. 25. The questionnaire may include questions related to whether the supplier's products are available for visual appraisal; whether the products are grouped together and identifiable by such or whether the products are individually identified, and whether the supplier can provide supporting documentation for either option; whether the supplier can provide documentation recording the products' ages; and whether the supplier's production of the products is seasonal or continues throughout the year. Other questions may include whether the supplier's previous year's sales and/or shipping records are available for review; whether the supplier can provide general information about its product operation; whether the exact age of each product can be provided (month/day/year), as opposed to a general range of age for a group of products; whether the supplier has provided products of this nature or similar products in prior years; whether the supplier can provide documentation showing the products are individually identified, such as, for example, an RFID tag for an animal product; whether the supplier can attest to the product having a known source and age; whether the supplier received the product from another source or whether the supplier reared, grew, or otherwise made the product; if the product was received from another source, the type of source; and whether the supplier has participated in training sessions related to age and source verification and provided by the administrator.

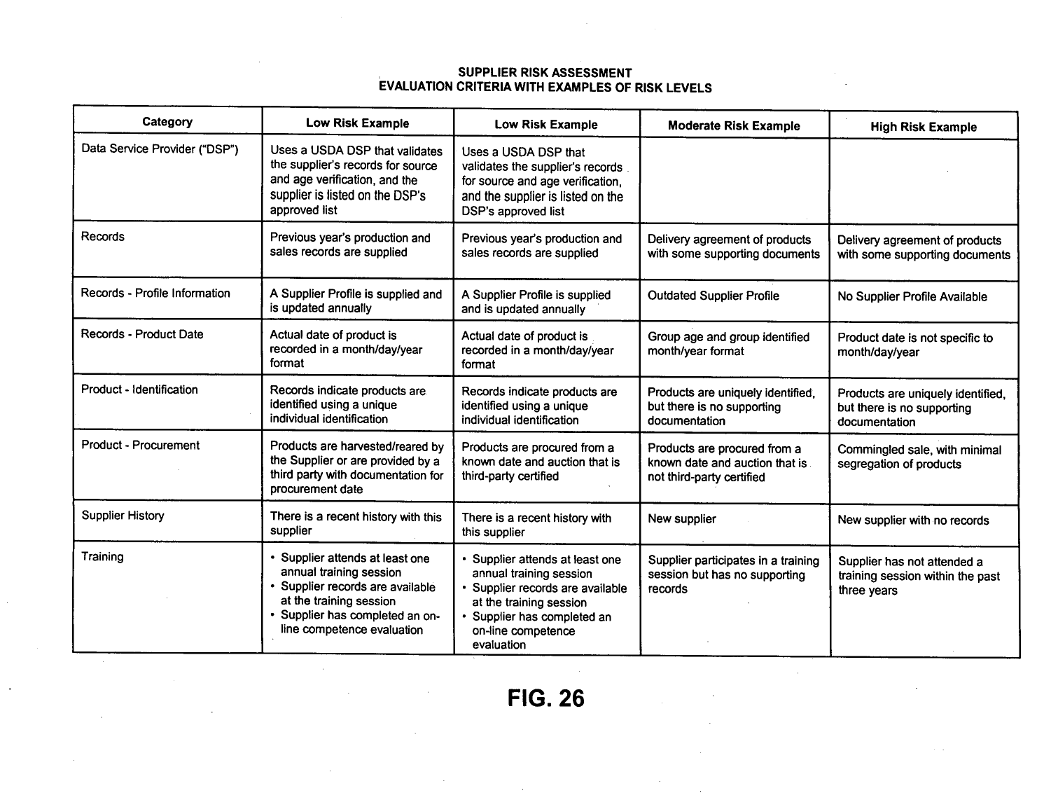

Based on the answers to the questionnaire and the corresponding documents that the supplier is able to produce, the computer program assigns the supplier a risk assessment score. This score may comprise any arbitrary value but preferably represents a range of values for which the supplier may be scored as “low risk,” “moderate risk,” or “high risk,” as illustrated in FIG. 26. For “low” and “moderate” risk suppliers, the computer program identifies the supplier as capable of providing products that meet minimum age and source verification requirements. As can be appreciated, the minimum product verification requirements will differ depending on the product. For example, animal products may require a verified birth date or possible ranges of dates of birth, whereas a plant product may only require a verified year of harvesting. Similarly, animal products may require a verified source, so as to track a group of animals and the animals' association with other animals. “Minimum product verification requirements” is to be herein interpreted as the minimum requirements for verifying the age and source of the products, including the supplier's ability to provide supporting documentation to verify the age and the source of the products.

Should the computer program score the supplier as “high risk” based on the supplier's answers to the questionnaire, then the administrator may choose to perform an on-site evaluation. The on-site evaluation comprises visiting the supplier's place of business to review the supplier's documents, mode of operation, and other relevant material for evaluating and assessing the supplier's ability to meet the minimum requirements. The administrator may then score the supplier based on the administrator's on-site review.

Should the supplier ultimately be scored as “high risk,” then the supplier is not approved by the computer program as a supplier capable of verifying the age and source of its products. Within the context of the QSA or PVP program, should age and source verification be necessary for USDA approval, then the computer program alerts the administrator as part of the initial audits of the supplier.

Should the supplier ultimately be scored as “low” or “moderate” risk, then the supplier is listed by the computer program as an approved supplier. The USDA representative who conducts an audit of the supplier will then be able to review and determine that the supplier is an approved supplier and is capable of meeting minimum age and source verification requirements. Alternatively, the supplier may be listed as an approved supplier based on other methods, in which case the computer program notes that the supplier is approved by the other method. Other methods include the supplier already being a USDA QSA or PVP approved supplier, or the supplier is already verified by a third party that is approved to verify the age and source of a product, otherwise known as a USDA Data Service Provider.

With respect to the training sessions noted above and part of the initial evaluation questionnaire, the computer program includes a training module that the supplier may access via the communications network in order to complete the training. The training session preferably includes instructions, advice, and other information on how the supplier may better verify the age and source of its products, such as by establishing a protocol for maintaining supporting documentation. Preferably, the computer program, as part of the ongoing evaluation of the supplier discussed below, monitors the training completed by the supplier and incorporates such as a factor in the risk assessment score. Alternatively, the supplier may participate in a centralized training session that is given at a particular location and conducted by trained personnel. The computer program is then informed of the supplier's participation in the centralized training session. Preferably, the supplier is required to attend or otherwise complete at least one training session in a three-year period.

As part of the ongoing evaluation and assessment of suppliers that are initially approved as meeting the minimum age and source verification requirements, the computer program automatically audits each supplier every year. As part of the automatic audit, the computer program will instruct the administrator to request supporting documentation from the supplier or otherwise answer relevant questions. Alternatively, the computer program may automatically notify the supplier, without intervention from the administrator, of the yearly audit and subsequently request from the supplier the supporting documentation or answers to proffered questions.

Although the above has been described in the context of the administrator performing the initial evaluation and auditing of the supplier, it may be that the USDA representative performs the initial evaluation and otherwise identifies the supplier as an approved supplier. The computer program may then obtain the necessary supporting documentation from the supplier within the parameters of the QSA and PVP program so as to assist the USDA representative in performing the periodic audits that are subsequent to the initial evaluation or audit. The computer program would then perform the periodic audits thereafter, or alternatively, the USDA representative would perform the periodic audits. In any event, the computer program would receive and store information relating to age and source verification for review by the USDA representative. In preferable operation, the computer program of the present invention performs the initial evaluation and periodic audits with oversight by the administrator, and the USDA representative periodically randomly audits a certain number of audits performed by the computer program so as to determine that the quality assessment and verification program of the present invention is meeting minimum USDA standards. A further alternative is that the computer program, with oversight from the administrator, randomly selects a certain percentage of suppliers, such as ten percent, to audit each period, as opposed to auditing every supplier every period.

Although the invention has been described with reference to the preferred embodiment illustrated in the attached drawing figures, it is noted that equivalents may be employed and substitutions made herein without departing from the scope of the invention as recited in the claims. For example, the website created by the computer program may take any of a variety of forms and appearances.

Having thus described the preferred embodiment of the invention, what is claimed as new and desired to be protected by Letters Patent includes the following:

1. A computer-readable medium encoded with a computer program for enabling a computer to implement a quality systems management program, the computer program including code segments for:
(a) receiving and storing information relating to a quality management program implemented by a supplier of commercial products;
(b) receiving and storing an electronic document, wherein the document relates to the quality management program and confirms that the management program complies with a government-sponsored quality systems assessment program; and
(c) enabling a government representative to selectively view the quality management program information and the electronic document via a remote computer.

2. The computer-readable medium as set forth in claim 1, further comprising a code segment for:
(d) enabling the supplier to edit the electronic document via a remote computer.

3. The computer-readable medium as set forth in claim 1, further comprising a code segment for
(e) generating an electronic quality manual form with a default appearance and content.

4. The computer-readable medium as set forth in claim 3, further comprising a code segment for
(f) enabling the administrator to remotely modify the appearance and content of the quality manual form.

5. The computer-readable medium as set forth in claim 4, further comprising a code segment for
(g) generating a quality manual by combining the quality management program information, the document, and the quality manual form.

6. The computer-readable medium as set forth in claim 5, wherein the quality manual is electronic and presents a link to the electronic document.

7. The computer-readable medium as set forth in claim 1, further comprising a code segment for
(h) receiving information relating to a plurality of quality management programs and for receiving a plurality of documents relating to the plurality of management programs.

8. The computer-readable medium as set forth in claim 7, further comprising a code segment for
(i) enabling the government representative to selectively view information relating to each of the quality management programs and each of the documents.

9. The computer-readable medium as set forth in claim 1, further comprising a code segment for
(j) assigning a status to each user of the computer program and selectively granting access to the quality management program information and the document base on a user's status.

10. The computer-readable medium as set forth in claim 9, wherein the user status is chosen from the group consisting of administrator, supplier, USDA representative, and general user.

11. The computer-readable medium as set forth in claim 1, further comprising a code segment for
(k) receiving, storing, and presenting information relating to the location, name, type, category, and revision date of the document.

12. The computer-readable medium as set forth in claim 1, further comprising a code segment for
(l) adding, editing, and managing supplier profile information.

13. The computer-readable medium as set forth in claim 12, wherein the supplier profile information includes information relating to a manager of the supplier's quality management program.

14. The computer-readable medium as set forth in claim 1, further comprising a code segment for
(m) managing and presenting livestock tag information.

15. A computer-readable medium encoded with a computer program for enabling a computer to implement a quality systems management program, the computer program including code segments for:
(a) generating a website and selectively providing website access to a quality systems management program administrator, a plurality of agricultural suppliers, and a government representative;
(b) providing a quality manual form available via the website, wherein the form is electronic and is remotely editable by the administrator;
(c) generating a quality manual for each supplier by receiving supplier quality management program information from the administrator, combining the quality management program information with information from the quality manual form, and presenting the combined information via the web site;
(d) enabling the administrator to remotely add an electronic document to each of the quality manuals, wherein each document contains information relating to a quality management program and confirms that at least a portion of the quality management program complies with a government-sponsored quality systems assessment program;
(e) providing a link from each manual to a document;
(f) enabling each supplier to remotely edit a document corresponding to the supplier; and
(g) enabling the government representative to selectively and remotely view each of the manuals and the documents.

16. The computer-readable medium as set forth in claim 15, further including a code segment for:
(h) automatically notifying the administrator when a document is changed.

17. The computer-readable medium as set forth in claim 16, further including a code segment for:
(i) automatically notifying the government representative when a manual or a document is changed.

18. The computer-readable medium as set forth in claim 16, further including a code segment for:
(j) enabling the government representative and the administrator to determine which portions of each manual and which portions of each document will trigger a notification when changed.

19. A method of implementing a quality systems management program, the method comprising the steps of:
(a) assisting a supplier of commercial products in developing a quality management program for the supplier that complies with a government-sponsored quality systems assessment program;
(b) creating an electronic quality manual containing information relating to the quality management program;
(c) preparing an electronic document required by the quality management program and making the document accessible via the manual; and
(d) enabling a government representative to remotely conduct a review of the document to verify compliance with the quality systems assessment program.

20. The method as set forth in claim 19, further comprising the step of:
(e) enabling the supplier to remotely view, edit, and complete the document.

21. The method as set forth in claim 19, further comprising the step of:
(f) consulting with the supplier to update the quality management system and the electronic documents in response to changes in the supplier's business and changes in the requirements of the quality systems assessment program.

22. The method as set forth in claim 19, further comprising the step of:
(g) electronically publishing an approval status of the supplier.

23. The method as set forth in claim 19, further comprising the step of:
(h) making the electronic quality manual accessible to an employee of the supplier in the employee's work environment.

24. The method as set forth in claim 23, step (h) further comprising the step of:
(h1) providing a computer in the employee's work environment for accessing the manual via a computer network.

25. A computer-readable medium encoded with a computer program for enabling a computer to evaluate a supplier of a commercial product as to the supplier's ability to verify an age and a source of its product, the computer program including code segments for:
(a) receiving and storing information regarding the age and the source of the product;
(b) based on the information received, assessing the supplier's ability to verify the age and the source of the product so as to meet minimum product verification requirements; and
(c) should the supplier be assessed as able to verify the age and the source of the product, identifying the supplier as an approved supplier.

26. The computer-readable medium as set forth in claim 25, wherein step (a) further comprises providing the supplier a questionnaire related to product handling, dating, and an extent to which the supplier can provide supporting documentation for the age and the source of the product.

27. The computer-readable medium as set forth in claim 25, further comprising step (d) of periodically assessing the supplier to ensure the supplier is continuing to provide products meeting the minimum product verification requirements.

28. The computer-readable medium as set forth in claim 25, where step (b) further comprises assigning the supplier a risk assessment score that represents the supplier's ability to verify the age and the source of its products.

29. The computer-readable medium as set forth in claim 28, further comprising step (e) of providing a training session for use by the supplier, wherein completion of the training session is a factor in assigning the risk assessment score.

30. The computer-readable medium as set forth in claim 25, further comprising step (f) of enabling a government representative to view the supplier assessment.
